(19) United States
(12) Patent Application Publication
(10) Pub. No.: US 2026/0261391 A1
(43) Pub. Date: Sep. 3, 2026

(54) METHOD AND APPARATUS FOR ACTIVATING OR DEACTIVATING RESOURCE

(71) Applicant: Beijing Xiaomi Mobile Software Co., Ltd., Beijing (CN)

(72) Inventor: Xiaolong LI, Beijing (CN)

(73) Assignee: Beijing Xiaomi Mobile Software Co., Ltd., Beijing (CN)

(21) Appl. No.: 18/878,744

(22) PCT Filed: Jun. 29, 2022
(86) PCT No.: PCT/CN2022/102550

§ 371 Date: Dec. 24, 2024

(51) Int. Cl. H04L 5/00

(52) U.S. Cl. CPC H04L 5/0098; H04L 5/0051

(57) ABSTRACT

Disclosed in embodiments of the present disclosure are a method and apparatus for activating or deactivating a resource, applicable to the technical field of communications. The method performed by an anchor node comprises: after determining resource control information used for activating or deactivating a resource and corresponding to a designated terminal device in a radio resource control (RRC) inactivate state, the anchor node sends the resource control information to a serving node. Thus, according to the resource control information, the serving node may activate or deactivate a resource corresponding to the designated terminal device, thereby avoiding the failure of positioning activation or deactivation, avoiding resource waste, and improving the positioning reliability.

### CROSS-REFERENCE TO RELATED APPLICATIONS

This application is a national stage of International Application No. PCT/CN2022/102550, filed on Jun. 29, 2022, which is hereby incorporated by reference in its entirety.

### TECHNICAL FIELD

The present disclosure relates to the field of communication technology, and in particular, to a method and apparatus for activating or deactivating resources.

### BACKGROUND

In small data transmission (SDT) that does not require anchor relocation, i.e., SDT without anchor relocation, a serving node can allocate resources, e.g., a sounding reference signal (SRS) resource, to a terminal device in an inactive state. How to activate or deactivate resources are an urgent problem to be solved at present.

### SUMMARY

Embodiments of the present disclosure provide a method and apparatus for activating or deactivating resources.

In a first aspect, an embodiment of the present disclosure provides a method for activating or deactivating resources, performed by an anchor node, including: determining resource control information corresponding to a specified terminal device, where the resource control information is configured to activate or deactivate a resource corresponding to the specified terminal device, and the specified terminal device is in a radio resource control (RRC) inactive state; and sending the resource control information to a serving node.

In the present disclosure, the anchor node determines the resource control information for activating or deactivating the resource corresponding to the specified terminal device in the RRC inactive state, and sends the resource control information to the serving node. Thus, according to the resource control information, the serving node may activate or deactivate the resource corresponding to the specified terminal device, thereby avoiding the failure of positioning activation or deactivation, avoiding resource waste, and improving the positioning reliability.

In a second aspect, an embodiment of the present disclosure provides another method for activating or deactivating resources, performed by a serving node, including: receiving resource control information sent by an anchor node, where the resource control information is configured to activate or deactivate a resource corresponding to a specified terminal device, and the specified terminal device is in a radio resource control (RRC) inactive state; and activating or deactivating the resource corresponding to the specified terminal device according to the resource control information.

In the present disclosure, the serving node receives the resource control information, sent by the anchor node, that is configured to activate or deactivate the resource corresponding to the specified terminal device in the RRC inactive state, and the serving node activates or deactivates, based on the resource control information, the resource corresponding to the specified terminal device. Thus, the failure of positioning activation or deactivation is avoided, resource waste is avoided, and the positioning reliability is improved.

In a third aspect, an embodiment of the present disclosure provides a communication apparatus, including: a processing module, configured to determine resource control information corresponding to a specified terminal device, where the resource control information is configured to activate or deactivate a resource corresponding to the specified terminal device, and the specified terminal device is in a radio resource control (RRC) inactive state; and a transceiving module, configured to send the resource control information to a serving node.

In a fourth aspect, an embodiment of the present disclosure provides a communication apparatus, including: a transceiving module, configured to receive resource control information sent by an anchor node, where the resource control information is configured to activate or deactivate a resource corresponding to a specified terminal device, and the specified terminal device is in a radio resource control (RRC) inactive state; and a processing module, configured to activate or deactivate the resource corresponding to the specified terminal device according to the resource control information.

In a fifth aspect, an embodiment of the present disclosure provides a communication device, including: a processor, and when the processor executes a computer program in a memory, the method according to the first aspect is implemented.

In a sixth aspect, an embodiment of the present disclosure provides a communication device, including: a processor, and when the processor executes a computer program in a memory, the method according to the second aspect is implemented.

In a seventh aspect, an embodiment of the present disclosure provides a communication device, including a processor and a memory, where the memory stores a computer program; the processor is configured to executes the computer program stored in the memory, to cause the communication device to perform the method according to the first aspect.

In an eighth aspect, an embodiment of the present disclosure provides a communication device, including a processor and a memory, where the memory stores a computer program; the processor is configured to executes the computer program stored in the memory, to cause the communication device to perform the method according to the second aspect.

In a ninth aspect, an embodiment of the present disclosure provides a communication device, including a processor and an interface circuit, where the interface circuit is configured to receive a code instruction and transmit the code instruction to the processor, and the processor is configured to execute the code instruction, to cause the device to perform the method according to the first aspect.

In a tenth aspect, an embodiment of the present disclosure provides a communication device, including a processor and an interface circuit, where the interface circuit is configured to receive a code instruction and transmit the code instruction to the processor, and the processor is configured to execute the code instruction, to cause the device to perform the method according to the second aspect.

In an eleventh aspect, an embodiment of the present disclosure provides a system for activating or deactivating resources, where the system includes the communication apparatus according to the third aspect and the communication apparatus according to the fourth aspect; or the system includes the communication device according to the fifth aspect and the communication device according to the sixth aspect; or the system includes the communication device according to the seventh aspect and the communication device according to the eighth aspect; or the system includes the communication device according to the ninth aspect and the communication device according to the tenth aspect.

In a twelfth aspect, an embodiment of the present disclosure provides a computer-readable storage medium, configured to store an instruction used by the anchor node, and when the instruction is executed, the anchor node is caused to perform the method according to the first aspect.

In a thirteenth aspect, an embodiment of the present disclosure provides a readable storage medium, configured to store an instruction used by the serving node, and when the instruction is executed, the serving node is caused to perform the method according to the second aspect.

In a fourteenth aspect, the present disclosure provides a computer program product, including a computer program, where when the computer program is running on a computer, the computer is caused to perform the method according to the first aspect.

In a fifteenth aspect, the present disclosure provides a computer program product, including a computer program, where when the computer program is running on a computer, the computer is caused to perform the method according to the second aspect.

In a sixteenth aspect, the present disclosure provides a chip system, including at least one processor and an interface, where the chip system is configured to support the anchor node to implement functions in the first aspect, for example, functions of determining or processing at least one of data and information in the methods. In a possible design, the chip system further includes a memory, and the memory is configured to store a computer program and data that are necessary for the anchor node. The chip system may include a chip, or may include the chip and another separate device.

In a seventeenth aspect, the present disclosure provides a chip system, including at least one processor and an interface, where the chip system is configured to support the serving node to implement functions in the second aspect, for example, functions of determining or processing at least one of data and information in the methods. In a possible design, the chip system further includes a memory, and the memory is configured to store a computer program and data that are necessary for the serving node. The chip system may include a chip, or may include the chip and another separate device.

According to an eighteenth aspect, the present disclosure provides a computer program, where when the computer program is running on a computer, the computer is caused to perform the method according to the first aspect.

According to a nineteenth aspect, the present disclosure provides a computer program, where when the computer program is running on a computer, the computer is caused to perform the method according to the second aspect.

### BRIEF DESCRIPTION OF DRAWINGS

In order to more clearly describe the technical solutions in the embodiments or the background of the present disclosure, the accompanying drawings required in the embodiments or the background of the present disclosure will be described below.

FIG. 1 is a schematic architectural diagram of a communication system according to an embodiment of the present disclosure.

FIG. 2 is a schematic flowchart of a method for activating or deactivating resources according to an embodiment of the present disclosure.

FIG. 3 is a schematic flowchart of another method for activating or deactivating resources according to an embodiment of the present disclosure.

FIG. 4 is a schematic flowchart of another method for activating or deactivating resources according to an embodiment of the present disclosure.

FIG. 5 is a schematic flowchart of another method for activating or deactivating resources according to an embodiment of the present disclosure.

FIG. 6 is a schematic flowchart of another method for activating or deactivating resources according to an embodiment of the present disclosure.

FIG. 7 is a schematic flowchart of another method for activating or deactivating resources according to an embodiment of the present disclosure.

FIG. 8 is a schematic flowchart of another method for activating or deactivating resources according to an embodiment of the present disclosure.

FIG. 9 is a schematic flowchart of another method for activating or deactivating resources according to an embodiment of the present disclosure.

FIG. 10 is a schematic flowchart of another method for activating or deactivating resources according to an embodiment of the present disclosure.

FIG. 11A is a schematic flow diagram showing interactions of another method for activating or deactivating resources according to an embodiment of the present disclosure.

FIG. 11B is a schematic flow diagram showing interactions of another method for activating or deactivating resources according to an embodiment of the present disclosure.

FIG. 12 is a schematic flow diagram showing interactions of another method for activating or deactivating resources according to an embodiment of the present disclosure.

FIG. 13 is a schematic flow diagram showing interactions of another method for activating or deactivating resources according to an embodiment of the present disclosure.

FIG. 14 is a schematic flow diagram showing interactions of another method for activating or deactivating resources according to an embodiment of the present disclosure.

FIG. 15 is a schematic flow diagram showing interactions of another method for activating or deactivating resources according to an embodiment of the present disclosure.

FIG. 16 is a schematic structural diagram of a communication apparatus according to an embodiment of the present disclosure.

FIG. 17 is a schematic structural diagram of another communication apparatus according to an embodiment of the present disclosure.

FIG. 18 is a schematic structural diagram of a chip according to an embodiment of the present disclosure.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the present disclosure. Rather, they are merely examples of apparatuses and methods consistent with some aspects of the present disclosure as detailed in the appended claims.

To facilitate understanding, terms used in the present disclosure will first be described.

### 1. Sounding Reference Signal (SRS)

The SRS in wireless communication is configured to estimate frequency-domain information of an uplink channel, and perform frequency selective scheduling, or is configured to estimate a downlink channel and perform downlink beamforming. The terminal device sends an SRS, as an uplink signal, to help the network device obtain channel state information of each user. In a 5G system, SRS may be used for resource scheduling, link adaptation, massive MIMO (multiple-input multiple-output) and beam management, and the like.

Referring to FIG. 1, FIG. 1 is a schematic architectural diagram of a communication system according to an embodiment of the present disclosure. The communication system may include but is not limited to one network device and one terminal device, and a quantity and form of devices shown in FIG. 1 are merely examples, and do not constitute a limitation on the embodiments of the present disclosure. In practice, there may be two or more network devices, and two or more terminal devices. For example, the communication system shown in FIG. 1 includes two network devices, namely, a serving node 11 and an anchor node 12, and one terminal device 13.

It should be noted that the technical solutions of the embodiments of the present disclosure may be applied to various communication systems. For example, a long term evolution (LTE) system, a 5th generation (5G) mobile communication system, a 5G new radio (NR) system, or another future new mobile communication system.

The serving node 11 and the anchor node 12 in the embodiments of the present disclosure include an evolved NodeB (eNB), a transmission reception point (TRP), a next generation NodeB (gNB) in an NR system, a base station in another future mobile communication system, an access node in a wireless fidelity (WiFi) system, or the like. Specific technologies and specific device forms used by the network device are not limited in the embodiments of the present disclosure. The network device provided in the embodiments of the present disclosure may include a central unit (CU) and a distributed unit (DU), where the CU may also be referred to as a control unit, by adopting a CU-DU structure, protocol layers of the network device (for example, a base station) may be separated, functions of some protocol layers are centrally controlled by the CU, and functions of some or all of the remaining protocol layers are distributed in the DU, and the DU is centrally controlled by the CU.

The terminal device 13 in the embodiments of the present disclosure is a user-side entity used to receive or transmit a signal, for example, a mobile phone. The terminal device may also be referred to as a terminal, user equipment (UE), a mobile station (MS), a mobile terminal (MT), or the like. The terminal device may be an automobile with a communication function, a smart automobile, a mobile phone, a wearable device, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, or the like. Specific technologies and specific device forms used by the terminal device are not limited in the embodiments of the present disclosure.

It may be understood that the communication system described in the embodiments of the present disclosure is intended to describe the technical solutions of the embodiments of the present disclosure more clearly, and does not constitute a limitation on the technical solutions provided in the embodiments of the present disclosure. Those skilled in the art may know that with the evolution of system architecture and the emergence of new business scenarios, the technical solutions provided by the embodiments of the present disclosure are also applicable to similar technical problems.

Generally, in a scenario of SDT without anchor relocation, when a terminal device is in an inactive state, the terminal device may move to a new network node, that is, a serving gNB (or may also be referred to as a receiving gNB). The serving gNB may allocate a resource, for example, an SRS resource, to the terminal device. However, as context information of the terminal device is still stored in an anchor gNB, and the anchor node cannot directly activate or deactivate the resource allocated by the serving node, failure of terminal device positioning may be caused.

In the present disclosure, the anchor node may send activation or deactivation-related information to the serving node, so that the serving node activates or deactivates the resource of the terminal device in the inactive state based on the related information. Thus, failure of positioning activation is avoided, and positioning reliability is improved.

It should be noted that, in the present disclosure, the method for activating or deactivating resources provided in any embodiment may be performed separately, or may be performed together with a possible implementation method in another embodiment, or may be performed together with any technical solution in related technologies.

Embodiments of the present disclosure will be further described with reference to the accompanying drawings and specific embodiments.

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of the present disclosure as detailed in the appended claims.

The terminology used in the embodiments of the present disclosure is for the purpose of describing particular embodiments only and is not intended to limit the embodiments of the present disclosure. The singular forms “a/an”, “the”, and “said” used in the embodiments of the present disclosure and the appended claims are also intended to include plural forms unless the context clearly indicates other meanings. It should also be understood that the term “and/or ” as used herein refers to and includes any or all possible combinations of one or more associated listed item.

Depending on context, the word “if” and “in response to” as used herein may be interpreted as “when” or “upon” or “in response to determining”.

Embodiments of the present disclosure are described in detail below, examples of which are shown in the accompanying drawings, where the same or similar reference numerals denote the same or similar elements throughout. The embodiments described below with reference to the accompanying drawings are examples and are intended to explain the present disclosure, and cannot be construed as limiting the present disclosure.

In the present disclosure, the serving gNB may also be referred to as the receiving gNB or a new NG-RAN node, and the anchor gNB may also be referred to as a last serving gNB or an old NG-RAN node.

Referring to FIG. 2, FIG. 2 is a schematic flowchart of a method for activating or deactivating resources according to an embodiment of the present disclosure, where the method is performed by an anchor node. As shown in FIG. 2, the method may include but is not limited to following steps 201 and 202.
Step 201, determining resource control information corresponding to a specified terminal device, where the resource control information is configured to activate or deactivate a resource corresponding to the specified terminal device, and the specified terminal device is in a radio resource control (RRC) inactive state.

Optionally, the resource control information includes at least one of: resource activation information, where the resource activation information is configured to activate the resource corresponding to the specified terminal device; or resource deactivation information, where the resource deactivation information is configured to deactivate the resource corresponding to the specified terminal device.

In the present disclosure, the resource control information may include resource activation information for activating resources. The anchor node may determine, based on information related to positioning of the specified terminal device, the resource activation information corresponding to the specified terminal device. Further, the serving node is instructed to reserve a to-be-activated resource, and the serving node is instructed to activate, based on the resource activation information, the resource corresponding to the specified terminal device. In such way, the specified terminal device may start to use the corresponding resource for positioning, to avoid failure of positioning activation and improve positioning reliability.

Alternatively, the resource control information may include resource deactivation information for deactivating resources. When determining that the specified terminal device accesses to another network node, the anchor node determines the resource deactivation information corresponding to the terminal device, so as to indicate the serving node to release the to-be-deactivated resource, and to indicate the serving node to deactivate the resource corresponding to the specified terminal device. In such way, the terminal device can stop positioning by using the activated resource, thereby avoiding resource waste.

Optionally, the resource activation information of the resource control information includes at least one of: an identifier of the specified terminal device, a sounding reference signal (SRS) resource set identifier, an SRS resource identifier, information of a resource spatially related to a to-be-activated SRS, a first activation time, a first activation duration, and a first indication indicating whether the serving node simultaneously sends the resource control information and an RRC release message to the specified terminal device.

The identifier of the specified terminal device may be any information that can uniquely determine the specified terminal device, for example, a number of the terminal device. The identifier of the SRS resource set may be any information that can uniquely determine a specified SRS resource set, for example, a number of the SRS resource set. The identifier of the SRS resource may be any information that can uniquely determine a specified SRS resource, for example, a number of the SRS resource. The information of a resource spatially related to a to-be-activated SRS may be any other information with a spatial relationship with the to-be-activated SRS, for example, an identifier of another signal having a spatial relationship with the to-be-activated SRS.

Optionally, the resource deactivation information in the resource control information includes at least one of: identifier information of the specified terminal device, a deactivated SRS resource identifier, a deactivated SRS resource set identifier, and a deactivation indication.

The deactivation indication may be used to indicate to deactivate the resource corresponding to the specified terminal device. Specific description of the identifier of the terminal device, the identifier of the SRS resource, and the identifier of the SRS resource set, can be referred from detailed description of any embodiment of the present disclosure, and details will not be repeated herein.
Step 202, sending the resource control information to a serving node.

In the present disclosure, the anchor node may send the resource activation information to the serving node. Then, the serving node may determine the specified terminal device based on the identifier of the specified terminal device in the resource activation information, and send the resource activation information to the specified terminal device. In such way, the specified terminal device may activate, based on the resource activation information, the SRS resource indicated in the resource activation information at the first activation time, and keep the SRS resource in the activated state within the first activation duration, and may actively deactivate the SRS resource after the first activation duration expires, thereby avoiding deactivating the SRS resource by using additional deactivation signaling, and avoiding resource waste.

Alternatively, the serving node may determine the specified terminal device based on the identifier of the specified terminal device in the resource deactivation information, and deactivate the resource of the specified terminal device. Therefore, resource waste is avoided.

Optionally, the resource control information may be included in at least one of following messages and sent to the serving node: a retrieve terminal device context failure message, a radio access network (RAN) paging message, an Xn interface application procedure protocol message, a retrieve terminal device context confirmation message, a positioning activation request message, or a positioning deactivation request message.

In the present disclosure, the anchor node determines the resource control information for activating or deactivating the resource corresponding to the specified terminal device in the RRC inactive state, and sends the resource control information to the serving node. Thus, according to the resource control information, the serving node may activate or deactivate the resource corresponding to the specified terminal device, thereby avoiding the failure of positioning activation or deactivation, avoiding resource waste, and improving the positioning reliability.

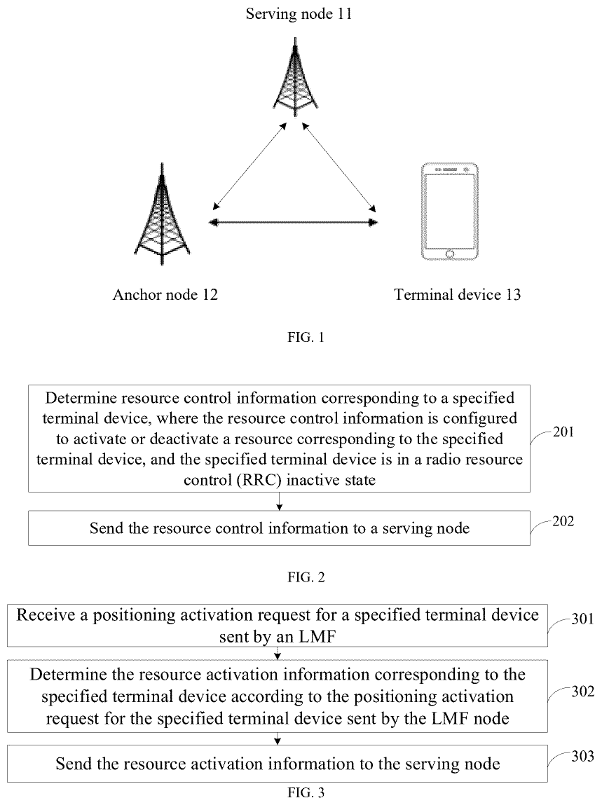

Referring to FIG. 3, FIG. 3 is a schematic flowchart of a method for activating or deactivating resources according to an embodiment of the present disclosure, where the method is performed by an anchor node. As shown in FIG. 3, the method may include but is not limited to following steps 301-303.
Step 301: receiving a positioning activation request for a specified terminal device sent by an LMF.

Specific description of the specified terminal device can be referred from the detailed description of any embodiment of the present disclosure, which will not be repeated herein.

In the present disclosure, when the location management function (LMF) determines that positioning information needs to be obtained, for example, when currently obtained positioning information is insufficient to accurately locate the position of the specified terminal device and the location information needs to be obtained, the LMF may send the positioning activation request for the specified terminal device to the anchor node to obtain the positioning information of the specified terminal device. The positioning activation request may include information such as an identifier of the specified terminal device, which is not limited in the present disclosure.
Step 302, determining the resource activation information corresponding to the specified terminal device according to the positioning activation request for the specified terminal device sent by the LMF node.

Detailed description of the resource activation information can be referred from the detailed description of any embodiment of the present disclosure, which will not be repeated herein.

In the present disclosure, the anchor node may determine the specified terminal device according to the identifier of the specified terminal device in the positioning activation request for the specified terminal device, and then may generate the resource activation information corresponding to the specified terminal device.
Step 303: sending the resource activation information to the serving node.

In the present disclosure, specific processes of step 303 may be referred from detailed description of any embodiment of the present disclosure, which will not be repeated herein.

In the present disclosure, after receiving the positioning activation request for the specified terminal device sent by the LMF, the anchor node may determine the resource activation information corresponding to the specified terminal device according to the positioning activation request for the specified terminal device sent by the LMF node, and then send the resource activation information to the serving node. Thus, according to the resource control information, the serving node may activate the resource corresponding to the specified terminal device, thereby avoiding the failure of positioning activation, and improving the positioning reliability.

Referring to FIG. 4, FIG. 4 is a schematic flowchart of a method for activating or deactivating resources according to an embodiment of the present disclosure, where the method is performed by an anchor node. As shown in FIG. 4, the method may include but is not limited to following steps 401-403.
Step 401: receiving a positioning deactivation request for a specified terminal device sent by an LMF.

Specific description of the specified terminal device can be referred from the detailed description of any embodiment of the present disclosure, which will not be repeated herein.

In the present disclosure, when the LMF determines that positioning information does not need to be obtained, for example, when currently obtained positioning information is sufficient to accurately locate the position of the specified terminal device and the location information may no longer need to be obtained, the LMF may send the positioning deactivation request for the specified terminal device to the anchor node to avoid unnecessary positioning and waste of resources. The positioning deactivation request may include information such as an identifier of the specified terminal device, which is not limited in the present disclosure.
Step 402, determining the resource deactivation information corresponding to the specified terminal device according to the received positioning deactivation request for the specified terminal device sent by the LMF node.

Detailed description of the resource activation information can be referred from the detailed description of any embodiment of the present disclosure, which will not be repeated herein.

In the present disclosure, the anchor node may determine the specified terminal device according to the identifier of the specified terminal device in the positioning deactivation request for the specified terminal device, and then may determine a resource corresponding to the specified terminal device and generate the resource deactivation information corresponding to the specified terminal device, so as to indicate the serving node to release the resource corresponding to the terminal device.

Optionally, when the specified terminal device sends an RRC resume request to access the anchor node by using another network node, it indicates that the specified terminal device stops using the corresponding resource, and in this case, the resource deactivation information corresponding to the specified terminal device may be determined based on the RRC resume request.

Optionally, when the specified terminal device sends an RRC connection request to access the anchor node by using another network node, it indicates that the specified terminal device stops using the corresponding resource, and in this case, the resource deactivation information corresponding to the specified terminal device may be determined based on the RRC connection request.
Step 403: sending the resource deactivation information to the serving node.

In the present disclosure, specific processes of step 403 may be referred from detailed description of any embodiment of the present disclosure, which will not be repeated herein.

In the present disclosure, after receiving the positioning deactivation request for the specified terminal device sent by the LMF, the anchor node may determine the resource deactivation information corresponding to the received specified terminal device according to the positioning deactivation request for the specified terminal device sent by the LMF node, and then send the resource deactivation information to the serving node. Thus, according to the resource control information, the serving node may deactivate the resource corresponding to the specified terminal device, thereby avoiding waste of resources.

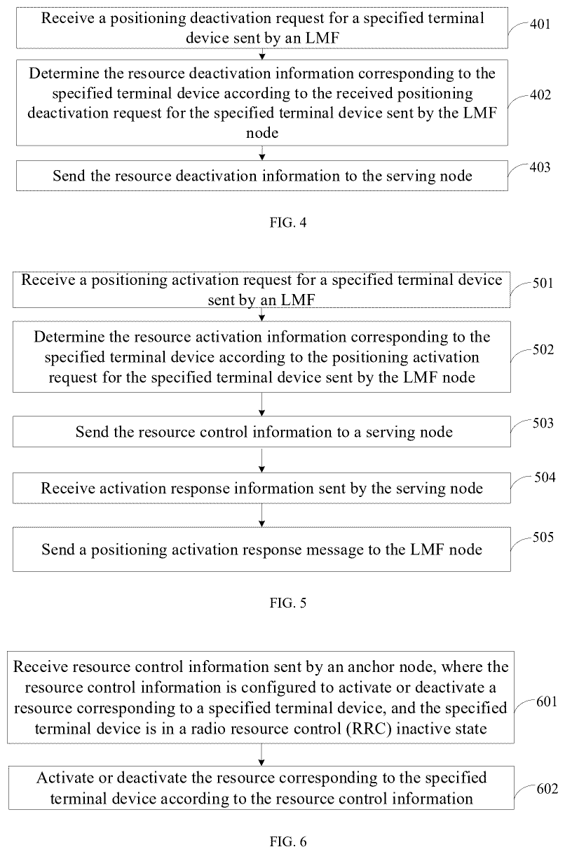

Referring to FIG. 5, FIG. 5 is a schematic flowchart of a method for activating or deactivating resources according to an embodiment of the present disclosure, where the method is performed by an anchor node. As shown in FIG. 5, the method may include but is not limited to following steps 501-505.
Step 501, receiving a positioning activation request for a specified terminal device sent by an LMF.
Step 502, determining the resource activation information corresponding to the specified terminal device according to the positioning activation request for the specified terminal device sent by the LMF node.
Step 503, sending the resource control information to a serving node.

In the present disclosure, specific processes of steps 501-503 may be referred from detailed description of any embodiment of the present disclosure, which will not be repeated herein.
Step 504: receiving activation response information sent by the serving node.

The activation response information may include at least one of: a second activation time and a second activation duration. The second activation time is an SRS activation time determined by the serving node, and the second activation duration is an SRS activation duration determined by the serving node.

In the present disclosure, when the serving node receives the resource activation information sent by the anchor node, if the resource activation information does not include time-related information, for example, does not include the first activation time and the first activation duration, the serving node may determine the time-related information for resource activation, for example, the second activation time and the second activation duration; alternatively, the resource activation information includes time-related information, but the serving node may also determine, according to an actual network condition, whether to activate the resource of the specified terminal device according to the first activation time and the first activation duration in the resource control information. If the serving node determines not to activate the resource of the specified terminal device based on the first activation time and the first activation duration in the resource control information, the serving node may determine the second activation time and the second activation duration by the serving node itself. After determining the second activation time and the second activation duration, the serving node may send the activation response message to the anchor node, to synchronize the second activation time and the second activation duration. It may be understood that the second activation time may be same as or different from the first activation time, and the second activation duration may be same as or different from the first activation duration.

Optionally, the anchor node may also receive deactivation response information sent by the serving node.

In the present disclosure, when the serving node receives the resource deactivation information sent by the anchor node, the serving node deactivates the resource of the specified terminal device according to the resource control information, or may re-determine the deactivation time according to the actual network condition, and send deactivation response information to the anchor node to synchronize information such as the deactivation time to the anchor node.

Optionally, the activation response information and the deactivation response information may be included in at least one of following messages and sent to the serving node: a retrieve terminal device context failure message, an RAN paging message, an Xn interface application procedure protocol message, a retrieve terminal device context confirmation message, a positioning activation request message, or a positioning deactivation request message, etc.
Step 505: sending a positioning activation response message to the LMF node.

In the present disclosure, when receiving a positioning activation request sent by the LMF, the anchor node may correspondingly send a positioning activation response message to the LMF node to synchronize configurations related to the LMF positioning activation. In such way, the LMF may send positioning measurement request to a corresponding network node based on the positioning activation response message, to obtain positioning information of the specified terminal device. The positioning activation response message may be same as the activation response information, or partially same.

Optionally, when receiving a positioning deactivation request sent by the LMF, the anchor node may correspondingly send a positioning deactivation response message to the LMF node to synchronize configurations related to the LMF positioning deactivation.

In the present disclosure, after receiving the positioning activation request for the specified terminal device sent by the LMF, the anchor node may determine the resource activation information corresponding to the specified terminal device according to the positioning activation request for the specified terminal device sent by the LMF node, and send the resource control information to the serving node, and receive the activation response information sent by the serving node and send the positioning activation response message to the LMF node. In such way, with interaction of information related to the activation resource between each network node, the positioning activation accuracy can be ensured while the positioning activation failure is avoided, and the positioning activation reliability is improved.

Referring to FIG. 6, FIG. 6 is a schematic flowchart of a method for activating or deactivating resources according to an embodiment of the present disclosure, where the method is performed by a serving node. As shown in FIG. 6, the method may include but is not limited to following steps 601 and 602.
Step 601, receiving resource control information sent by an anchor node, where the resource control information is configured to activate or deactivate a resource corresponding to a specified terminal device, and the specified terminal device is in a radio resource control (RRC) inactive state.

Optionally, the resource control information includes at least one of: resource activation information, where the resource activation information is configured to activate the resource corresponding to the specified terminal device; or resource deactivation information, where the resource deactivation information is configured to deactivate the resource corresponding to the specified terminal device.

In the present disclosure, the resource control information may include resource activation information for activating resources. The anchor node may determine, based on information related to positioning of the specified terminal device, the resource activation information corresponding to the specified terminal device. Further, the serving node is instructed to reserve a to-be-activated resource, and the serving node is instructed to activate, based on the resource activation information, the resource corresponding to the specified terminal device. In such way, the specified terminal device may start to use the corresponding resource for positioning, to avoid failure of positioning activation and improve positioning reliability.

Alternatively, the resource control information may include resource deactivation information for deactivating resources. When determining that the specified terminal device accesses to another network node, the anchor node determines the resource deactivation information corresponding to the terminal device, so as to indicate the serving node to release the to-be-deactivated resource, and to indicate the serving node to deactivate the resource corresponding to the specified terminal device. In such way, the terminal device can stop positioning by using the activated resource, thereby avoiding resource waste.

Optionally, the resource activation information of the resource control information includes at least one of: an identifier of the specified terminal device, a sounding reference signal (SRS) resource set identifier, an SRS resource identifier, information of a resource spatially related to a to-be-activated SRS, a first activation time, a first activation duration, and a first indication indicating whether the serving node simultaneously sends the resource control information and an RRC release message to the specified terminal device.

The identifier of the specified terminal device may be any information that can uniquely determine the specified terminal device, for example, a number of the terminal device. The identifier of the SRS resource set may be any information that can uniquely determine a specified SRS resource set, for example, a number of the SRS resource set. The identifier of the SRS resource may be any information that can uniquely determine a specified SRS resource, for example, a number of the SRS resource. The information of a resource spatially related to a to-be-activated SRS may be any other information with a spatial relationship with the to-be-activated SRS, for example, an identifier of another signal having a spatial relationship with the to-be-activated SRS.

Optionally, the resource deactivation information in the resource control information includes at least one of: identifier information of the specified terminal device, a deactivated SRS resource identifier, a deactivated SRS resource set identifier, and a deactivation indication.

The deactivation indication may be used to indicate to deactivate the resource corresponding to the specified terminal device. Specific description of the identifier of the terminal device, the identifier of the SRS resource, and the identifier of the SRS resource set, can be referred from detailed description of any embodiment of the present disclosure, and details will not be repeated herein.

Optionally, the resource control information is included in at least one of following messages and sent to the serving node: a retrieve terminal device context failure message, a radio access network (RAN) paging message, an Xn interface application procedure protocol message, a retrieve terminal device context confirmation message, a positioning activation request message, or a positioning deactivation request message.
Step 602, activating or deactivating the resource corresponding to the specified terminal device according to the resource control information.

In the present disclosure, after receiving the resource activation information, the serving node may determine the specified terminal device based on the identifier of the specified terminal device in the resource activation information, and send the resource activation information to the specified terminal device. In such way, the specified terminal device may activate, based on the resource activation information, the SRS resource indicated in the resource activation information at the first activation time, and keep the SRS resource in the activated state within the first activation duration, and may actively deactivate the SRS resource after the first activation duration expires, thereby avoiding deactivating the SRS resource by using additional deactivation signaling, and avoiding resource waste.

Alternatively, the serving node may determine the specified terminal device based on the identifier of the specified terminal device in the resource deactivation information, and deactivate the resource of the specified terminal device. Therefore, resource waste is avoided.

In the present disclosure, the serving node receives the resource control information, sent by the anchor node, that is configured to activate or deactivate the resource corresponding to the specified terminal device in the RRC inactive state, and the serving node activates or deactivates, based on the resource control information, the resource corresponding to the specified terminal device. Thus, the failure of positioning activation or deactivation is avoided, resource waste is avoided, and the positioning reliability is improved.

Referring to FIG. 7, FIG. 7 is a schematic flowchart of a method for activating or deactivating resources according to an embodiment of the present disclosure, where the method is performed by a serving node. As shown in FIG. 7, the method may include but is not limited to following steps 701 and 702.
Step 701, receiving resource control information sent by an anchor node, where the resource control information is configured to activate or deactivate a resource corresponding to a specified terminal device, and the specified terminal device is in a radio resource control (RRC) inactive state.

In the present disclosure, specific processes of step 701 may be referred from detailed description of any embodiment of the present disclosure, which will not be repeated herein.
Step 702, in response to determining that the resource control information includes information for activating the resource corresponding to the specified terminal device, sending information indicating to activate the resource and an RRC release message to the specified terminal.

In the present disclosure, after receiving the resource control information, in response to determining that the resource control information includes the information configured to activate the resource corresponding to the specified terminal device, the serving node can send the information configured to activate the resource together with the RRC release message to the specified terminal device. In such way, the specified terminal device can use the activation resource to perform positioning measurement, for example, send the SRS resource.

Optionally, in response to determining that the resource control information includes information for activating the resource corresponding to the specified terminal device, the serving node can send information indicating to activate the resource to the specified terminal device through a paging message. The information indicating to activate the resource may be same as or different from the information for activating the resource corresponding to the specified terminal device included in the resource control information.

Optionally, in response to determining that the resource control information includes information for activating the resource corresponding to the specified terminal device, the serving node can send information indicating to activate the resource to the specified terminal device through an RRC release message.

In the present disclosure, the serving node receives the resource control information, sent by the anchor node, that is configured to activate or deactivate the resource corresponding to the specified terminal device in the RRC inactive state, and then the serving node may send information indicating to activate the resource to the specified terminal device through a paging message in response to determining that the resource control information includes information for activating the resource corresponding to the specified terminal device. Thus, failure of positioning activation is avoided, and positioning reliability is improved.

Referring to FIG. 8, FIG. 8 is a schematic flowchart of a method for activating or deactivating resources according to an embodiment of the present disclosure, where the method is performed by a serving node. As shown in FIG. 8, the method may include but is not limited to following steps 801 and 802.
Step 801, receiving resource control information sent by an anchor node, where the resource control information is configured to activate or deactivate a resource corresponding to a specified terminal device, and the specified terminal device is in a radio resource control (RRC) inactive state.

In the present disclosure, specific processes of step 801 may be referred from detailed description of any embodiment of the present disclosure, which will not be repeated herein.
Step 802, in response to determining that the resource control information includes information for deactivating the resource corresponding to the specified terminal device, releasing the resource corresponding to the specified terminal device.

In the present disclosure, the anchor node may determine the specified terminal device according to the identifier of the specified terminal device in the positioning deactivation request for the specified terminal device sent by the LMF, and then may determine a resource corresponding to the specified terminal device and generate the resource deactivation information corresponding to the specified terminal device, so as to indicate the serving node to release the resource corresponding to the terminal device, thereby avoiding waste of resources.

Optionally, when the specified terminal device sends an RRC resume request to access the anchor node by using another network node, it indicates that the specified terminal device is not within a serving range of the serving node, and in this case, the resource deactivation information corresponding to the specified terminal device may be determined based on the RRC resume request.

Optionally, when the specified terminal device sends an RRC connection request to access the anchor node by using another network node, it indicates that the specified terminal device is not within a serving range of the serving node, and in this case, the resource deactivation information corresponding to the specified terminal device may be determined based on the RRC connection request.

In the present disclosure, the serving node receives the resource control information, sent by the anchor node, that is configured to activate or deactivate the resource corresponding to the specified terminal device in the RRC inactive state, and then the serving node may release the resource corresponding to the specified terminal device in response to determining that the resource control information includes information for deactivating the resource corresponding to the specified terminal device. Therefore, resource waste is avoided.

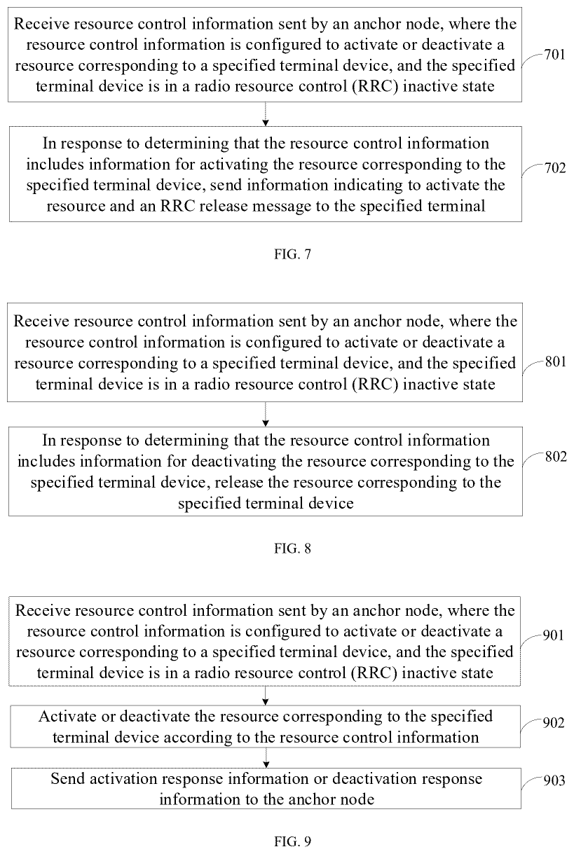

Referring to FIG. 9, FIG. 9 is a schematic flowchart of a method for activating or deactivating resources according to an embodiment of the present disclosure, where the method is performed by a serving node. As shown in FIG. 9, the method may include but is not limited to following steps 901-903.
Step 901, receiving resource control information sent by an anchor node, where the resource control information is configured to activate or deactivate a resource corresponding to a specified terminal device, and the specified terminal device is in a radio resource control (RRC) inactive state.
Step 902, activating or deactivating the resource corresponding to the specified terminal device according to the resource control information.

In the present disclosure, specific processes of steps 901-902 may be referred from detailed description of any embodiment of the present disclosure, which will not be repeated herein.
Step 903, sending activation response information or deactivation response information to the anchor node.

The activation response information may include at least one of: a second activation time and a second activation duration. The second activation time is an SRS activation time determined by the serving node, and the second activation duration is an SRS activation duration determined by the serving node.

In the present disclosure, when the serving node receives the resource activation information sent by the anchor node, if the resource activation information does not include time-related information, for example, does not include the first activation time and the first activation duration, the serving node may determine the time-related information for resource activation, for example, the second activation time and the second activation duration; alternatively, the resource activation information includes time-related information, but the serving node may also determine, according to an actual network condition, whether to activate the resource of the specified terminal device according to the first activation time and the first activation duration in the resource control information. If the serving node determines not to activate the resource of the specified terminal device based on the first activation time and the first activation duration in the resource control information, the serving node may determine the second activation time and the second activation duration by the serving node itself. After determining the second activation time and the second activation duration, the serving node may send the activation response message to the anchor node, to synchronize the second activation time and the second activation duration. It may be understood that the second activation time may be same as or different from the first activation time, and the second activation duration may be same as or different from the first activation duration.

Optionally, the serving node may also send deactivation response information to the anchor node.

In the present disclosure, when the serving node receives the resource deactivation information sent by the anchor node, the serving node deactivates the resource of the specified terminal device according to the resource control information, or may re-determine the deactivation time according to the actual network condition, and send deactivation response information to the anchor node to synchronize information such as the deactivation time to the anchor node.

Optionally, the activation response information and the deactivation response information may be included in at least one of following messages and sent to the serving node: a retrieve terminal device context failure message, an RAN paging message, an Xn interface application procedure protocol message, a retrieve terminal device context confirmation message, a positioning activation request message, or a positioning deactivation request message, etc.

Optionally, the serving node may also perform step 903 first, and then step 902. That is, after receiving the resource control message, the serving node does not directly activate or deactivate the resource corresponding to the specified terminal device, but first sends activation response information or deactivation response information to the anchor node, so as to send the second activation time and the second activation duration to the anchor node, and then activate or deactivate the resource corresponding to the specified terminal device after receiving the RRC release message sent by the anchor node.

In the present disclosure, the serving node receives the resource control information, sent by the anchor node, that is configured to activate or deactivate the resource corresponding to the specified terminal device in the RRC inactive state, and then the serving node may activate or deactivate the resource corresponding to the specified terminal device according to the resource control information, and may send the activation response information or the deactivation response information to the anchor node. In such way, with interaction of information related to the activation resource between each network node, the positioning activation accuracy can be ensured while the positioning activation failure is avoided, and the positioning activation reliability is improved.

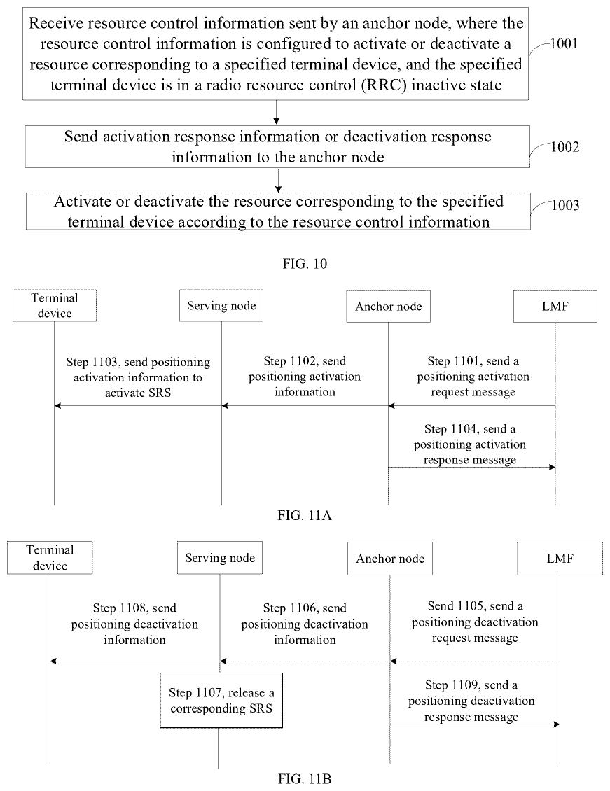

Referring to FIG. 10, FIG. 10 is a schematic flowchart of a method for activating or deactivating resources according to an embodiment of the present disclosure, where the method is performed by a serving node. As shown in FIG. 10, the method may include but is not limited to following steps 1001-1003.
Step 1001, receiving resource control information sent by an anchor node, where the resource control information is configured to activate or deactivate a resource corresponding to a specified terminal device, and the specified terminal device is in a radio resource control (RRC) inactive state.

In the present disclosure, specific processes of step 1001 may be referred from detailed description of any embodiment of the present disclosure, which will not be repeated herein.
Step 1002, sending activation response information or deactivation response information to the anchor node.

Optionally, when the specified terminal device is in the RRC inactive state, it indicates that RRC is occupied, and in this case, the resource corresponding to the specified terminal device may not be activated, and after the RRC release message sent by the anchor node is received, the resource corresponding to the specified terminal device is activated.

Optionally, when the resource control information includes a first indication, and the first indication indicates the serving node to simultaneously send the resource control information and the RRC release message to the specified terminal device, and the resource corresponding to the specified terminal device is not activated before the RRC release message sent by the anchor node is received.
Step 1003, activating or deactivating the resource corresponding to the specified terminal device according to the resource control information.

In the present disclosure, specific processes of step 1003 may be referred from detailed description of any embodiment of the present disclosure, which will not be repeated herein.

In the present disclosure, the serving node receives the resource control information, sent by the anchor node, that is configured to activate or deactivate the resource corresponding to the specified terminal device in the RRC inactive state, and then the serving node may not activate the resource corresponding to the terminal device before receiving the RRC release message sent by the anchor node, and may send the activation response information or the deactivation response information to the anchor node, and then activate or deactivate the resource corresponding to the terminal device according to the resource control information. Thus, failure of positioning activation or deactivation is avoided, and positioning reliability is improved.

The method for activating or deactivating resources is further described below. In the present disclosure, resource activation or deactivation may be implemented in following manners.

### Manner 1

Referring to FIG. 11A, the method includes following steps 1101-1104.
Step 1101, an LMF sends a positioning activation request message to an anchor gNB.
Step 1102, the anchor gNB sends positioning activation information to a serving gNB.

According to an embodiment, the positioning activation information may be included in a retrieve terminal device context failure message (Retrieve UE Context Failure message); according to another embodiment, the positioning activation information may be included in a RAN paging message. It should be understood that the message including the positioning activation information is not limited thereto. The positioning activation information is the resource activation information.

The positioning activation information may include at least one of following pieces of information: an SRS resource set identifier (SRS Resource Set ID), indicating an SRS resource that needs to be activated; information spatially related to SRS, indicating a spatial relation corresponding to a to-be-activated SRS resource or a to-be-activated SRS resource set; an activation time, indicating a specific time of SRS activation, may be an absolute time or a relative time; or an activation duration, indicating a duration of SRS activation.

The activation time is a first activation time, and the activation duration is a first activation duration.
Step 1103: the serving gNB sends the positioning activation information to activate the SRS.

Optionally, the serving gNB sends a MAC CE (Media Access Control Control Element) for activating the SRS to the specified terminal device together with the RRC release message; or the serving gNB may also include the positioning activation information in the RRC release message, so that the specified terminal device activates the SRS based on the positioning activation information in the RRC release message; or the positioning activation information is included in a paging message and sent to the specified terminal device. It should be understood that this is merely an example, and how to enable the specified terminal device to activate the SRS is not limited thereto.

If the positioning activation information includes time information, for example, an activation time and/or an activation duration, the specified terminal device and the serving gNB may further activate or deactivate the corresponding SRS by considering a time of the time information, so that additional deactivation signaling may be avoided to deactivate the SRS.

In the present disclosure, the activation refers to that the specified terminal device starts to send the SRS and/or the gNB reserves the corresponding SRS resource, and the deactivation refers to that the specified terminal device stops sending the SRS and/or the gNB releases the reserved corresponding SRS resource.
Step 1104: the anchor gNB sends a positioning activation response message to the LMF.

An effect that can be achieved according to the method is: if the specified terminal device in the RRC inactive (RRC_INACTIVE) state moves to a new serving base station, that is, moves to the serving gNB, and a context of the specified terminal device is still in the anchor gNB, activation or deactivation of a semi-static SRS can be supported by using the present disclosure, thereby avoiding failure of positioning activation. At the same time, the present disclosure also supports a time-based deactivation method, which reduces a deactivation signaling procedure, and is more suitable for positioning of the specified terminal device in the RRC_INACTIVE state.

### Manner 2

Referring to FIG. 11B, the method includes following steps 1105-1109. As can be clearly determined from the specification and figures, FIGS. 11A and 11B are separate figures that do not rely upon each other to be able to be performed.
Step 1105, an LMF sends a positioning deactivation request message to an anchor gNB.

The positioning deactivation request message may include the resource deactivation information, for example, including: information related to an identifier (ID) of a terminal device, indicating a specific terminal device, that is, the specified terminal device; a deactivated SRS resource, indicating an SRS resource that needs to be deactivated, for example, an SRS resource set ID; and/or a deactivation indication, indicating to deactivate all SRS resources corresponding to the specified terminal device.
Step 1106, the anchor gNB sends positioning deactivation information to a serving gNB.
Step 1107: the serving gNB releases a corresponding SRS.
Step 1108, the serving gNB sends the positioning deactivation information to the terminal device.

The positioning deactivation information is the resource deactivation information.

After receiving the positioning deactivation information, the serving gNB may release a corresponding SRS resource, and indicate the terminal device to deactivate the corresponding SRS, that is, stop sending the SRS.
Step 1109: the anchor gNB sends a positioning deactivation response message to the LMF.

An effect that can be achieved according to the method is: if the specified terminal device in the RRC inactive (RRC_INACTIVE) state moves to a new serving base station, that is, moves to the serving gNB, and a context of the specified terminal device is still in the anchor gNB, deactivation of a semi-static SRS can be supported by using the present disclosure, thereby avoiding waste of resources.

### Manner 3

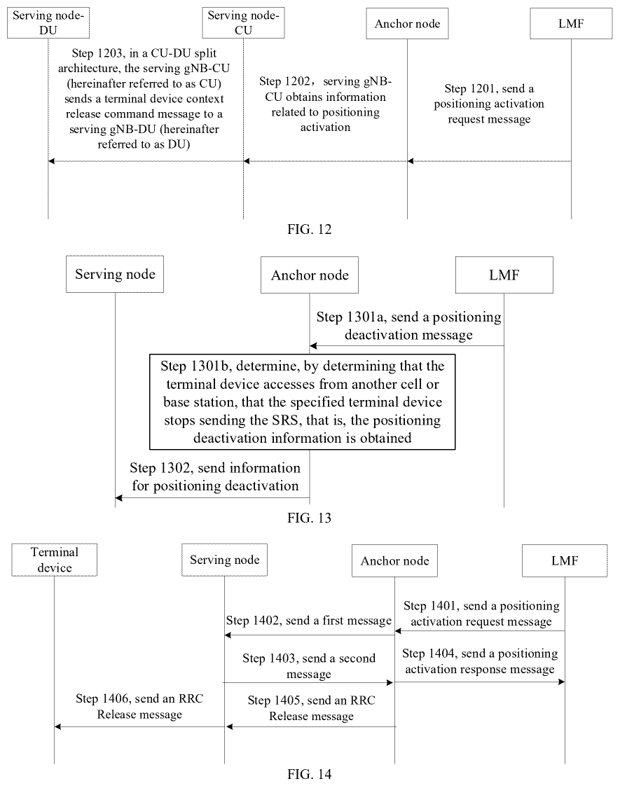

Referring to FIG. 12, the method includes following steps 1201-1203.
Step 1201, an LMF sends a positioning activation request message to an anchor gNB.
Step 1202: a serving gNB-CU obtains information related to positioning activation.
Step 1203: in a CU-DU split architecture, the serving gNB-CU (hereinafter referred to as CU) sends a terminal device context release command message to a serving gNB-DU (hereinafter referred to as DU).

The terminal device context release command message includes positioning activation information, and the positioning activation information may include at least one of following pieces of information: an SRS Resource Set ID, indicating an SRS resource that needs to be activated; information spatially related to SRS, indicating a spatial relation corresponding to a to-be-activated SRS resource or a to-be-activated SRS resource set; an activation time, indicating a specific time of SRS activation, may be an absolute time or a relative time; an activation duration, indicating a duration of SRS activation; or a first indication, notifying the DU that the MAC CE for activating the SRS needs to be sent to the specified terminal device together with the RRC release message.

The DU receives the positioning activation information, and activates an SRS and/or reserving an SRS resource by considering the information. According to an embodiment, the DU sends the MAC CE for activating the SRS to the specified terminal device together with the RRC Release message; according to another embodiment, the information for activating the SRS has been included in the RRC Release message, and the DU reserves the corresponding SRS resource for the specified terminal device according to the positioning activation information.

An effect that can be achieved according to the method is: in the CU-DU split architecture, if the specified terminal device in the RRC_INACTIVE state moves to a new serving base station, that is, moves to the serving gNB, and a context of the specified terminal device is still in the anchor gNB, activation or deactivation of a semi-static SRS can be supported by using the present disclosure, thereby avoiding failure of positioning activation. At the same time, the present disclosure also supports a time-based deactivation method, which reduces a deactivation signaling procedure, and is more suitable for positioning of the specified terminal device in the RRC_INACTIVE state.

### Manner 4

Referring to FIG. 13, the method includes following steps 1301a-1302.
Step 1301, an anchor gNB obtains positioning deactivation information.

According to an embodiment, in step 1301a, an LMF sends a positioning deactivation message to the anchor gNB, and the anchor gNB receives the positioning deactivation information from the LMF; according to another embodiment, in step 1301b, the specified terminal device initiates an RRC resume or RRC setup procedure from a gNB different from the serving gNB, and the anchor gNB may determine, by determining that the terminal device accesses from another cell or base station, that the specified terminal device stops sending the SRS, that is, the positioning deactivation information is obtained. It should be understood that this is merely an example, and a manner of obtaining the positioning deactivation information by the anchor gNB is not limited thereto.

The positioning deactivation information is the resource deactivation information.
Step 1302, the anchor gNB sends information for positioning deactivation to a serving gNB.

The information for positioning deactivation may be included in an XnAP message, for example, the positioning deactivation message. The information for positioning deactivation is the resource control information.

The information for positioning deactivation may include at least one of: information related to an identifier (ID) of a terminal device, indicating a specific terminal device, that is, the specified terminal device; a deactivated SRS resource, indicating an SRS resource that needs to be deactivated, for example, an SRS resource set ID, or a deactivation indication, indicating to deactivate all SRS resources corresponding to the specified terminal device.

The serving gNB considers the information for positioning deactivation, and releases a corresponding SRS resource.

An effect that can be achieved according to the method is: if the specified terminal device in the RRC_INACTIVE state moves to a new serving base station, that is, moves to the serving gNB, and a context of the specified terminal device is still in the anchor gNB, the serving gNB is enabled to release the SRS resource in time, thereby avoiding waste of resources.

### Manner 5

Referring to FIG. 14, the method includes following steps 1401-1406.
Step 1401, an LMF sends a positioning activation request message to an anchor gNB.
Step 1402, if a specified terminal device is under a serving gNB, the anchor gNB sends a first message to the serving gNB, where the first message includes request information for positioning activation. The first message may be an XnAP message, for example, may be a partial terminal device context transfer message (Partial UE Context Transfer message) or a positioning activation request message.

Response information for positioning activation may include at least one of: an SRS Resource Set ID, indicating an SRS resource that needs to be activated; information spatially related to SRS, indicating a spatial relation corresponding to a to-be-activated SRS resource or a to-be-activated SRS resource set; a first activation time, indicating a specific time of SRS activation requested by the LMF, may be an absolute time or a relative time; a first activation duration, indicating a duration of SRS activation requested by the LMF; or a first indication, notifying the serving gNB that the MAC CE for activating the SRS needs to be sent to the specified terminal device together with the RRC release message.
Step 1403, the serving gNB receives the message and the information, and sends a second message to the anchor gNB, where the second message includes response information for positioning activation. The second message may be an XnAP message, for example, may be a partial terminal device context transfer acknowledge message (Partial UE Context Transfer Acknowledge message) or a positioning activation response message.

Response information for positioning activation may include at least one of: a second activation time, indicating an SRS activation time determined by the serving gNB; or a second activation duration, indicating an SRS activation duration determined by the serving gNB.

The serving gNB does not activate the SRS corresponding to the terminal device based on the first indication, the SRS activation time determined by the serving gNB may be different from the first activation time, and the SRS activation duration determined by the serving gNB may be different from the first activation duration.

If the activated SRS is used for the specified terminal device in the RRC INACTIVE state or the first message includes the first indication, the serving gNB will not activate the SRS until receiving, from the anchor gNB, an XnAP message including the RRC Release message, for example, retrieve terminal device context failure message.

A manner of activating the SRS by the serving gNB is same as that described in step 103, and details will not be repeated herein.
Step 1404, the anchor gNB sends a positioning activation response message to the LMF, where the positioning activation response message may include the response information for positioning activation received in step 1403.

The LMF may start sending a measurement request to the base station participating in the positioning measurement by considering the information.
Step 1405 and step 1406: the anchor gNB sends the RRC release message to the specified terminal device through the serving gNB, where the serving gNB sends, based on the information received in step 1402, the MAC CE for activating the SRS to the specified terminal device together with the RRC release message.

An effect that can be achieved according to the method is: if the specified terminal device in the RRC_INACTIVE state moves to a new serving base station, and a context of the specified terminal device is still in the anchor gNB, activation or deactivation of a semi-static SRS can be supported by using the present disclosure, thereby avoiding failure of positioning activation, and also the serving gNB can determine whether positioning activation can be performed successfully.

### Manner 6

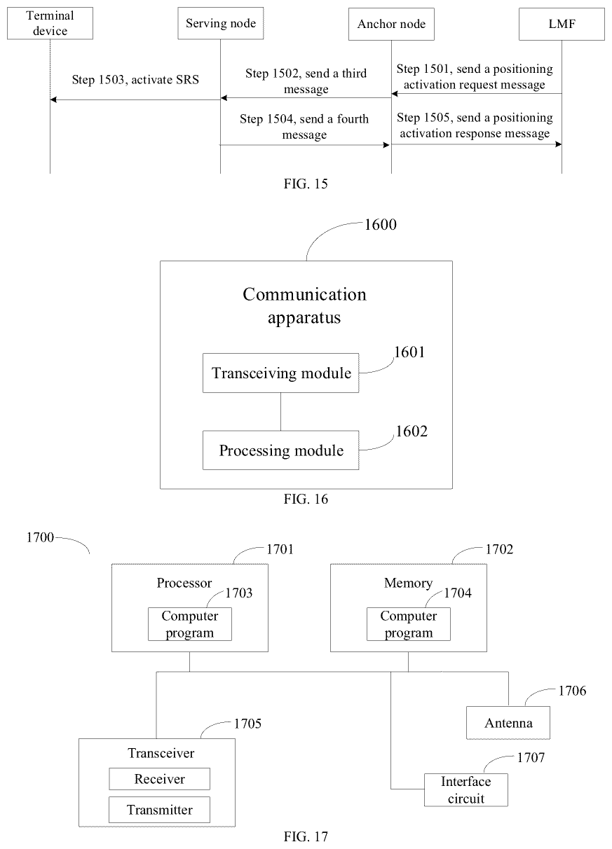

Referring to FIG. 15, the method includes following steps 1501-1501.
Step 1501, an LMF sends a positioning activation request message to an anchor gNB.
Step 1502, if a specified terminal device is under a serving gNB, the anchor gNB sends a third message to the serving gNB, where the third message includes request information for positioning activation. The third message may be a retrieve terminal device context failure message or a new XnAP message, for example, a positioning activation request message.

Response information for positioning activation may include at least one of: an SRS Resource Set ID, indicating an SRS resource that needs to be activated; information spatially related to SRS, indicating a spatial relation corresponding to a to-be-activated SRS resource or a to-be-activated SRS resource set; a first activation time, indicating a specific time of SRS activation requested by the LMF, may be an absolute time or a relative time; a first activation duration, indicating a duration of SRS activation requested by the LMF; or a first indication, notifying the serving gNB that the MAC CE for activating the SRS needs to be sent to the specified terminal device together with the RRC release message.
Step 1503: the serving gNB receives the message and the information, and activates the SRS by considering the information, and a manner for the serving gNB to activate the SRS is same as that described in step 1103, and details will not be repeated herein.
Step 1504, the serving gNB sends a fourth message to the anchor gNB, where the fourth message includes response information for positioning activation. The fourth message is an XnAP message, for example, a positioning activation response message. Optionally, the response information for positioning activation may include at least one of: a second activation, indicating an SRS activation determined by the serving gNB, or a second activation duration, indicating an SRS activation duration determined by the serving gNB.

As the serving gNB activates the SRS corresponding to the terminal device based on the first indication, the SRS activation time determined by the serving gNB is the first activation time, and the SRS activation duration determined by the serving gNB is the first activation duration.
Step 1505, the anchor gNB sends a positioning activation response message to the LMF, where the positioning activation response message may include the response information for positioning activation received in step 1504.

The LMF may start sending a positioning measurement request by considering the information.

An effect that can be achieved according to the method is: if the specified terminal device in the RRC_INACTIVE state moves to a new serving base station, and a context of the specified terminal device is still in the anchor gNB, activation or deactivation of a semi-static SRS can be supported by using the present disclosure, thereby avoiding failure of positioning activation, and also the LMF can be enabled to obtain accurate activation response information.

Referring to FIG. 16, FIG. 16 is a schematic structural diagram of a communication apparatus 1600 according to an embodiment of the present disclosure. The communications apparatus 1600 shown in FIG. 16 may include a transceiving module 1601. The transceiving module 1601 may include a sending module and/or a receiving module, the sending module is configured to implement a sending function, the receiving module is configured to implement a receiving function, and the transceiving module 1601 may implement the sending function and/or the receiving function.

It may be understood that the communication apparatus 1600 may be an anchor node, an apparatus in an anchor node, or an apparatus that can be matched with an anchor node for use.

The communication apparatus 1600 is on an anchor node side, including a processing module 1602, configured to determine resource control information corresponding to a specified terminal device, where the resource control information is configured to activate or deactivate a resource corresponding to the specified terminal device, and the specified terminal device is in a radio resource control (RRC) inactive state; and a transceiving module 1601, configured to send the resource control information to a serving node.

Optionally, the resource control information includes at least one of: resource activation information, where the resource activation information is configured to activate the resource corresponding to the specified terminal device; or resource deactivation information, where the resource deactivation information is configured to deactivate the resource corresponding to the specified terminal device.

Optionally, the transceiving module 1601 is configured to perform: determining the resource activation information corresponding to the specified terminal device according to a received positioning activation request for the specified terminal device sent by a location management function (LMF) node; or determining the resource deactivation information corresponding to the specified terminal device according to a received positioning deactivation request for the specified terminal device sent by the LMF node; or determining the resource deactivation information corresponding to the specified terminal device according to an RRC resume request sent by the specified terminal device to another network node; or determining the resource deactivation information corresponding to the specified terminal device according to an RRC connection request sent by the specified terminal device to another network node.

The other network node is any one node other than the anchor node.

Optionally, the processing module 1602 is configured to perform: in response to receiving the positioning activation request sent by the LMF node, sending a positioning activation response message to the LMF node; or in response to receiving the positioning deactivation request sent by the LMF node, sending a positioning deactivation response message to the LMF node.

Optionally, the resource control information is included in at least one of following messages and sent to the serving node: a retrieve terminal device context failure message (Retrieve UE Context Failure message); a radio access network (RAN) paging message; an Xn interface application flow protocol message; a retrieve terminal device context confirmation message; a positioning activation request message; or a positioning deactivation request message.

Optionally, the resource activation information of the resource control information includes at least one of: an identifier of the specified terminal device; a sounding reference signal (SRS) resource set identifier; an SRS resource identifier; information of a resource spatially related to a to-be-activated SRS; a first activation time; a first activation duration; or a first indication, where the first indication indicates whether the serving node simultaneously sends the resource control information and an RRC release message to the specified terminal device.

Optionally, the resource deactivation information of the resource control information includes at least one of: identifier information of the specified terminal device; a deactivated SRS resource identifier; a deactivated SRS resource set identifier; or a deactivation indication.

Optionally, the transceiving module 1601 is further configured to perform: receiving activation response information or deactivation response information sent by the serving node.

Optionally, the activation response information includes at least one of: a second activation time, where the second activation time is an SRS activation time determined by the serving node; or a second activation duration, where the second activation duration is an SRS activation duration determined by the serving node.

In the present disclosure, the anchor node determines the resource control information for activating or deactivating the resource corresponding to the specified terminal device in the RRC inactive state, and may send the resource control information to the serving node. Thus, according to the resource control information, the serving node may activate or deactivate the resource corresponding to the specified terminal device, thereby avoiding the failure of positioning activation or deactivation, avoiding resource waste, and improving the positioning reliability.

It should be noted that the apparatus embodiments are obtained based on the method embodiments, and for specific descriptions, the method embodiments can be referred to, and details will not be repeated herein.

It may be understood that the communication apparatus 1600 may be a serving node, an apparatus in a serving node, or an apparatus that can be matched with a serving node for use.

The communication apparatus 1600 is on a serving node side, including: a transceiving module 1601 and a processing module 1602.

The transceiving module 1601 is configured to receive resource control information sent by an anchor node, where the resource control information is configured to activate or deactivate a resource corresponding to a specified terminal device, and the specified terminal device is in a radio resource control (RRC) inactive state. The processing module 1602 is configured to activate or deactivate the resource corresponding to the specified terminal device according to the resource control information.

Optionally, the resource control information sent by the anchor node is included in at least one of following messages: a retrieve terminal device context failure message (Retrieve UE Context Failure message); a radio access network (RAN) paging message; an Xn interface application flow protocol message; a retrieve terminal device context confirmation message; a positioning activation request message; or a positioning deactivation request message.

Optionally, the resource control information includes at least one of: resource activation information, where the resource activation information is configured to activate the resource corresponding to the specified terminal device; or resource deactivation information, where the resource deactivation information is configured to deactivate the resource corresponding to the specified terminal device.

Optionally, the resource activation information of the resource control information includes at least one of: an identifier of the specified terminal device; a sounding reference signal (SRS) resource set identifier; an SRS resource identifier; information of a resource spatially related to a to-be-activated SRS; a first activation time; a first activation duration; or a first indication, where the first indication indicates whether the serving node simultaneously sends the resource activation information and an RRC release message to the specified terminal device.

Optionally, the resource deactivation information of the resource control information includes at least one of: identifier information of the specified terminal device; a deactivated SRS resource identifier; a deactivated SRS resource set identifier; or a deactivation indication.

Optionally, the processing module 1602 is configured to perform: in response to determining that the resource control information includes information for activating the resource corresponding to the specified terminal device, sending information indicating to activate the resource and an RRC release message to the specified terminal device; and/or in response to determining that the resource control information includes information for activating the resource corresponding to the specified terminal device, sending information indicating to activate the resource to the specified terminal device through a paging message; and/or in response to determining that the resource control information includes information for activating the resource corresponding to the specified terminal device, sending information indicating to activate the resource to the specified terminal device through an RRC release message; and/or in response to determining that the resource control information includes information for deactivating the resource corresponding to the specified terminal device, releasing the resource corresponding to the specified terminal device.

Optionally, the transceiving module 1601 is further configured to perform: sending activation response information or deactivation response information to the anchor node.

Optionally, the activation response information includes at least one of: a second activation time, where the second activation time is an SRS activation time determined by the serving node; or a second activation duration, where the second activation duration is an SRS activation duration determined by the serving node.

Optionally, the processing module 1602 is configured to perform: when the specified terminal device is in the RRC inactive state, not activating the resource corresponding to the specified terminal device before receiving an RRC release message sent by the anchor node; or not activating the resource corresponding to the specified terminal device before receiving the RRC release message sent by the anchor node according to a first indication included in the resource control information, where the first indication indicating to send resource activation information in the resource control information and the RRC release message to the specified terminal device simultaneously.

In the present disclosure, the serving node receives the resource control information, sent by the anchor node, that is configured to activate or deactivate the resource corresponding to the specified terminal device in the RRC inactive state, and the serving node activates or deactivates, based on the resource control information, the resource corresponding to the specified terminal device. Thus, the failure of positioning activation or deactivation is avoided, resource waste is avoided, and the positioning reliability is improved.

It should be noted that the apparatus embodiments are obtained based on the method embodiments, and for specific descriptions, the method embodiments can be referred to, and details will not be repeated herein.

Referring to FIG. 17, FIG. 17 is a schematic structural diagram of a communication device/apparatus 1700 according to an embodiment of the present disclosure. The communication device 1700 may be a network device, or a terminal device, or a chip, a chip system or a processor that supports the network device to implement the methods, or a chip, a chip system or a processor that supports the terminal device to implement any of the methods. The apparatus can be configured to implement the method described in the method embodiments, and specific descriptions can be referred from the method embodiments.

The communication device 1700 may include one or more processors 1701. The processor 1701 may be a general-purpose processor, a special-purpose processor, or the like. For example, the processor 1701 may be a baseband processor or a central processing unit. The baseband processor may be configured to process a communication protocol and communication data, and the central processing unit may be configured to control a communication device (for example, a base station, a baseband chip, a terminal device, a terminal device chip, a DU, or a CU), execute a computer program, and process data of the computer program.

Optionally, the communication apparatus 1700 may further include one or more memories 1702, where the one or more memories 1702 may store a computer program 1704, and the processor 1701 executes the computer program 1704, to cause the communication device 1700 to perform the method described in the method embodiments. Optionally, the memory 1702 may further store data. The communication device 1700 and the memory 1702 may be separately disposed, or may be integrated together.

Optionally, the communication device 1700 may further include a transceiver 1705 and an antenna 1706. The transceiver 1705 may be referred to as a transceiver unit, a transceiver device, a transceiver circuit, or the like, and is configured to implement a transceiving function. The transceiver 1705 may include a receiver and a transmitter, where the receiver may be referred to as a receiving device or a receiving circuit, and is configured to implement a receiving function; and the transmitter may be referred to as a transmitting device or a transmitting circuit, and is configured to implement a transmitting function.

Optionally, the communication device 1700 may further include one or more interface circuits 1707. The interface circuits 1707 are used to receive a code instruction and transmit the code instruction to the processor 1701. The processor 1701 runs the code instruction to cause the communication device 1700 to perform the method described in the method embodiments.

The communication device 1700 includes an anchor node: the transceiver 1705 is configured to perform step 202 in FIG. 2; step 301 and step 302 in FIG. 3; step 401 and step 403 in FIG. 4; and step 501, step 503, and step 504 in FIG. 5.

The communication device 1700 includes a serving node: the processor 1701 is configured to perform step 602 in FIG. 6; step 702 in FIG. 7; step 802 in FIG. 8; step 902 in FIG. 9; and step 1002 and step 1004 in FIG. 10.

In an implementation, the processor 1701 may include a transceiver configured to implement receiving and sending functions. For example, the transceiver may be a transceiver circuit, an interface, or an interface circuit. The transceiver circuit, the interface, or the interface circuit for implementing the receiving and sending functions may be separate or integrated together. The transceiver circuit, the interface, or the interface circuit may be configured to read and write code/data, or the transceiver circuit, the interface, or the interface circuit may be configured to transmit or transmit a signal.

In an implementation, the processor 1701 can store a computer program 1703, and the computer program 1703 runs on the processor 1701, to cause the communication device 1700 to perform the method described in the method embodiments. The computer program 1703 may be solidified in the processor 1701, in which case, the processor 1701 may be implemented by hardware.

In an implementation, the communication device 1700 may include a circuit, which may realize the function of sending or receiving or communicating in the method embodiments. The processor and transceiver described in the present disclosure can be implemented in an integrated circuit (IC), an analog IC, a radio frequency integrated circuit (RFIC), a mixed-signal IC, an application specific integrated circuit (ASIC), a printed circuit board (PCB), an electronic device, and the like. The processor and transceiver can also be manufactured by various IC process technologies, such as complementary metal oxide semiconductor (CMOS), n-type metal oxide semiconductor (NMOS), p-type metal oxide semiconductor (PMOS), bipolar junction transistor (BJT), bipolar CMOS (BiCMOS), silicon germanium (SiGe), gallium arsenide (GaAs), etc.

The communication device 1700 described in the embodiment may be a network device or an access network device (such as the terminal device in the method embodiments), but the scope of the communication device described in the present disclosure is not limited thereto, and the structure of the communication device may not be limited by FIG. 17. The communication device may be a stand-alone device or may be a part of a larger device. For example, the communication device may be: (1) stand-alone integrated circuit (IC), or chip, or chip system or subsystem; (2) a set of one or more ICs, optionally, the IC set may also include storage components for storing data and computer programs; (3) ASIC, such as a modem; (4) a module that can be embedded in other devices; (5) a receiver, a terminal device, an intelligent terminal device, a cellular phone, a wireless device, a handset, a mobile unit, a vehicle-mounted device, a network device, a cloud device, an artificial intelligence device, etc. ; and/or (6) others, etc.

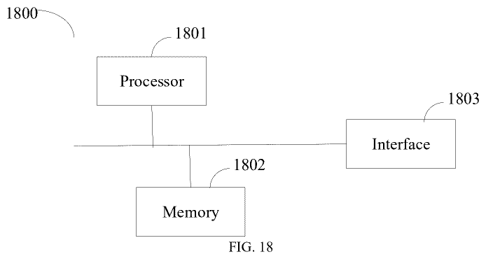

In a case that the communication device may be a chip or a chip system, the schematic structural diagram of the chip 1800 shown in FIG. 18 can be referred to. The chip 1800 shown in FIG. 18 includes a processor 1801 and an interface 1803. There may be one or more processors 1801, and one or more interfaces 1803.

In a case that the chip 1800 is configured to implement the function of the anchor node in the embodiments of the present disclosure: the interface 1803 is configured to perform step 202 in FIG. 2; step 301 and step 302 in FIG. 3; step 401 and step 403 in FIG. 4; and step 501, step 503, and step 504 in FIG. 5.

In a case that the chip 1800 is configured to implement the function of the serving node in the embodiments of the present disclosure:
the interface 1803 is configured to perform step 601 in FIG. 6; step 701 in FIG. 7; step 801 in FIG. 8; step 901 and step 903 in FIG. 9, step 1001 and step 1003 in FIG. 10, etc.

Optionally, the chip 1800 further includes a memory 1802 for storing necessary computer programs and data.

Those skilled in the art can also understand that various illustrative logical blocks and steps listed in the embodiments of the present disclosure can be implemented by electronic hardware, computer software, or a combination of both. Whether this function is implemented by hardware or software depends on the specific application and the design requirements of the whole system. Those skilled in the art can use various methods to realize the described functions for each specific application, but this realization should not be understood as beyond the scope of protection of the embodiments of the present disclosure.

The present disclosure also provides a non-transitory readable storage medium, storing an instruction, where when the instruction is executed by a computer, a function of any one of the method embodiments is implemented.

The present disclosure also provides computer program product, where when the computer program product is executed by a computer, a function of any one of the method embodiments is implemented.

The embodiments can be implemented in whole or in part by software, hardware, firmware or any combination thereof. When implemented in software, the embodiments can be fully or partially implemented in a form of a computer program product. The computer program product includes one or more computer programs. When the computer program is loaded and executed on a computer, a procedure or function according to the embodiment of the present disclosure is generated in whole or in part. The computer can be a general-purpose computer, a special-purpose computer, a computer network, or other programmable devices. The computer program can be stored in a computer-readable storage medium or transmitted from one computer-readable storage medium to another. For example, the computer program can be transmitted from a website, a computer, a server or a data center to another website, a computer, a server or a data center, through a wired manner (e.g., a coaxial cable, an optical fiber, a digital subscriber line) or a wireless manner (infrared, wireless, microwave). The computer-readable storage medium may be any available medium that a computer can access, or a data storage device such as a server, a data center and the like integrated by one or more available medium. The available medium may be a magnetic medium (e.g., floppy disk, hard disk, magnetic tape), an optical medium (e.g., high-density digital video disc (DVD)), or a semiconductor medium (e.g., solid state disk (SSD)) and the like.

It can be understood that “plural” in the present disclosure refers to two or more, and other quantifiers are similar. The “and/or” describes an association relationship of associated objects, indicating that there may be three relationships, for example, A and/or B may indicate three cases: A alone, both A and B, and B alone. The character “/” generally indicates that the objects are in an “OR” relationship. The singular forms “a/an”, “the”, and “said” are also intended to include plural forms unless the context clearly indicates other meanings.

It can be further understood that although the operations are described in a specific order in the drawings in the embodiment of the present disclosure, it should not be understood as requiring that these operations be performed in the specific order or serial order shown, or that all the operations shown should be performed to obtain the desired results. In certain circumstances, multitasking and parallel processing may be beneficial.

It can be understood by those skilled in the art that the “first”, “second” and other numerical numbers involved in the present disclosure are only for the convenience of description, and are not used to limit the scope of the embodiments of the present disclosure, but also indicate the order.

The “at least one of” in the present disclosure can also be described as one or more, and “a plurality of” may be two, three, four or more, which is not limited in the present disclosure. In the embodiments of the present disclosure, for a technical feature, technical features in the technical feature is distinguished by “first”, “second”, “third”, “A”, “B”, “C” and “D”. The technical features described by “first”, “second”, “third”, “A”, “B”, “C” and “D” are not ordered in sequence or in size.

The correspondence shown in each table in the present disclosure can be configured or predefined. Values of the information in each table are only examples, and can be configured as other values, which is not limited in the present disclosure. When configuring the correspondence between information and parameters, it is not necessary to configure all the correspondence indicated in each table. For example, in the table in the present disclosure, the corresponding relationship shown by some rows may not be configured. For another example, appropriate deformation adjustments can be made based on the table, such as splitting, merging and so on. The names of the parameters indicated by the headings in the tables can also be other names that can be understood by the communication device, and the values or representations of the parameters can also be other values or representations that can be understood by the communication device. Other data structures can also be used when the tables are implemented, such as arrays, queues, containers, stacks, linear tables, pointers, linked lists, trees, graphs, structures, classes, heaps, Hash tables, etc.

Pre-definition in the present disclosure can be understood as definition, definition in advance, storage, pre-storage, pre-negotiation, pre-configuration, solidifying, or pre-firing.

Those skilled in the art may notice that the units and algorithm steps of various examples described in connection with the embodiments disclosed herein can be implemented in electronic hardware, or a combination of computer software and electronic hardware. Whether these functions are implemented in hardware or software depends on the specific application and design constraints of the technical solution. Those skilled in the art can use different manners to implement the described functions for each specific application, but such implementation should not be considered beyond the scope of the present disclosure.

It can be clearly understood by those skilled in the art that for the convenience and conciseness of description, the specific working processes of the systems, devices and units described can refer to the corresponding processes in the method embodiments, and will not be repeated herein.

Other embodiments of the present disclosure will easily occur to those skilled in the art after considering the specification and practicing the present disclosure herein. The present application is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

The above is only the specific implementation of the present disclosure, but the protection scope of the present disclosure is not limited thereto. Any person familiar with the technical field can easily think of changes or substitutions within the technical scope disclosed in the present disclosure, which should be included in the protection scope of the present disclosure. Therefore, the protection scope of the present disclosure should be based on the protection scope of the claims.

1. A method for activating or deactivating resources, performed by an anchor node, comprising:
determining resource control information corresponding to a specified terminal device, wherein the resource control information is configured to activate or deactivate a resource corresponding to the specified terminal device, and the specified terminal device is in a radio resource control (RRC) inactive state; and
sending the resource control information to a serving node.

2. The method according to claim 1, wherein the resource control information comprises at least one of:
resource activation information, wherein the resource activation information is configured to activate the resource corresponding to the specified terminal device; or
resource deactivation information, wherein the resource deactivation information is configured to deactivate the resource corresponding to the specified terminal device.

3. The method according to claim 2,
wherein determining the resource control information corresponding to the specified terminal device comprises:
determining the resource activation information corresponding to the specified terminal device according to a received positioning activation request for the specified terminal device sent by a location management function (LMF) node; or
determining the resource deactivation information corresponding to the specified terminal device according to a received positioning deactivation request for the specified terminal device sent by the LMF node; or
determining the resource deactivation information corresponding to the specified terminal device according to an RRC resume request sent by the specified terminal device to another network node; or,
determining the resource deactivation information corresponding to the specified terminal device according to an RRC connection request sent by the specified terminal device to another network node, and
wherein the another network node is any one node other than the anchor node.

4. The method according to claim 3, further comprising:
in response to receiving the positioning activation request sent by the LMF node, sending a positioning activation response message to the LMF node; or
in response to receiving the positioning deactivation request sent by the LMF node, sending a positioning deactivation response message to the LMF node.

5. The method according to claim 1, wherein the resource control information is comprised in at least one of following messages and sent to the serving node:
a retrieve terminal device context failure message (Retrieve UE Context Failure message);
a radio access network (RAN) paging message;
an Xn interface application flow protocol message;
a retrieve terminal device context confirmation message;
a positioning activation request message; or
a positioning deactivation request message.

6. The method according to claim 2, wherein the resource activation information of the resource control information comprises at least one of:
an identifier of the specified terminal device;
a sounding reference signal (SRS) resource set identifier;
an SRS resource identifier;
information of a resource spatially related to a to-be-activated SRS;
a first activation time;
a first activation duration; or
a first indication, wherein the first indication indicates whether the serving node simultaneously sends the resource control information and an RRC release message to the specified terminal device.

7. The method according to claim 2, wherein the resource deactivation information of the resource control information comprises at least one of:
identifier information of the specified terminal device;
a deactivated sounding reference signal (SRS) resource identifier;
a deactivated SRS resource set identifier; or
a deactivation indication.

8. The method according to claim 1, further comprising:
receiving activation response information or deactivation response information sent by the serving node,
wherein the activation response information comprises at least one of:
a second activation time, wherein the second activation time is a sounding reference signal (SRS) activation time determined by the serving node; or
a second activation duration, wherein the second activation duration is an SRS activation duration determined by the serving node.

9. (canceled)

10. A method for activating or deactivating resources, performed by a serving node, comprising:
receiving resource control information sent by an anchor node, wherein the resource control information is configured to activate or deactivate a resource corresponding to a specified terminal device, and the specified terminal device is in a radio resource control (RRC) inactive state; and
activating or deactivating the resource corresponding to the specified terminal device according to the resource control information.

11. The method according to claim 10, wherein the resource control information sent by the anchor node is comprised in at least one of following messages:
a retrieve terminal device context failure message (Retrieve UE Context Failure message);
a radio access network (RAN) paging message;
an Xn interface application flow protocol message;
a retrieve terminal device context confirmation message;
a positioning activation request message; or
a positioning deactivation request message.

12. The method according to claim 10, wherein the resource control information comprises at least one of:
resource activation information, wherein the resource activation information is configured to activate the resource corresponding to the specified terminal device; or
resource deactivation information, wherein the resource deactivation information is configured to deactivate the resource corresponding to the specified terminal device.

13. The method according to claim 12, wherein the resource activation information of the resource control information comprises at least one of:
an identifier of the specified terminal device;
a sounding reference signal (SRS) resource set identifier;
an SRS resource identifier;
information of a resource spatially related to a to-be-activated SRS;
a first activation time;
a first activation duration; or
a first indication, wherein the first indication indicates whether the serving node simultaneously sends the resource activation information and an RRC release message to the specified terminal device.

14. The method according to claim 12, wherein the resource deactivation information of the resource control information comprises at least one of:
identifier information of the specified terminal device;
a deactivated sounding reference signal (SRS) resource identifier;
a deactivated SRS resource set identifier; or
a deactivation indication.

15. The method according to claim 12, wherein activating or deactivating the resource corresponding to the specified terminal device according to the resource control information comprises at least one of:
in response to determining that the resource control information comprises information for activating the resource corresponding to the specified terminal device, sending information indicating to activate the resource and an RRC release message to the specified terminal device; or
in response to determining that the resource control information comprises information for activating the resource corresponding to the specified terminal device, sending information indicating to activate the resource to the specified terminal device through a paging message; or
in response to determining that the resource control information comprises information for activating the resource corresponding to the specified terminal device, sending information indicating to activate the resource to the specified terminal device through an RRC release message; or
in response to determining that the resource control information comprises information for deactivating the resource corresponding to the specified terminal device, releasing the resource corresponding to the specified terminal device.

16. The method according to claim 10, further comprising:
sending activation response information or deactivation response information to the anchor node,
wherein the activation response information comprises at least one of:
a second activation time, wherein the second activation time is a sounding reference signal (SRS) activation time determined by the serving node; or
a second activation duration, wherein the second activation duration is an SRS activation duration determined by the serving node.

17. (canceled)

18. The method according to claim 10, wherein activating or deactivating the resource corresponding to the specified terminal device according to the resource control information comprises:
when the specified terminal device is in the RRC inactive state, not activating the resource corresponding to the specified terminal device before receiving an RRC release message sent by the anchor node; or
not activating the resource corresponding to the specified terminal device before receiving the RRC release message sent by the anchor node according to a first indication comprised in the resource control information, wherein the first indication indicates to send resource activation information in the resource control information and the RRC release message to the specified terminal device simultaneously.

19-20. (canceled)

21. A communication device, wherein the device comprises a processor and a memory, the memory stores a computer program, and the processor executes the computer program stored in the memory, to cause the device to implement the method according to claim 1.

22. A non-transitory computer-readable storage medium, storing an instruction, wherein when the instruction is executed, the method according to claim 1 is implemented.

23. A communication device, wherein the device comprises a processor and a memory, the memory stores a computer program, and the processor executes the computer program stored in the memory, to cause the device to implement the method according to claim 10.

24. A non-transitory computer-readable storage medium, storing an instruction, wherein when the instruction is executed, the method according to claim 10.
